(19) United States
(12) Patent Application Publication
(10) Pub. No.: US 2026/0091979 A1
(43) Pub. Date: Apr. 2, 2026

(54) Quantum-Grade Nanodiamonds and Related Methods

(71) Applicant: The Government of the United States of America, as represented by the Secretary of the Navy, Arlington, VA (US)

(72) Inventors: Boris N. Feigelson, Springfield, VA (US); Austin J. Cendejas, Alexandria, VA (US); Benjamin L. Greenberg, Washington, DC (US); Alan G. Jacobs, Rockville, MD (US)

(73) Assignee: The Government of the United States of America, as represented by the Secretary of the Navy, Arlington, VA (US)

(21) Appl. No.: 19/345,289

(22) Filed: Sep. 30, 2025

Related U.S. Application Data
(60) Provisional application No. 63/702,439, filed on Oct. 2, 2024.

(51) Int. Cl. C01B 32/26; B82Y 30/00; B82Y 40/00

(52) U.S. Cl. CPC C01B 32/26; B82Y 30/00; B82Y 40/00; C01P 2002/54; C01P 2002/77; C01P 2004/64; C01P 2004/80; C01P 2006/40

(57) ABSTRACT

According to some embodiments of the present disclosure, a method of forming quantum-grade nanodiamonds (Q-NDs) is provided. In particular, a plasma volume is provided in a reaction chamber of a plasma reactor, and molecular seeds are provided in the plasma volume. A carbon precursor is provided in the plasma volume to grow diamond around each of the molecular seeds in the plasma volume to provide nanodiamonds (NDs). Ones of the nanodiamonds (NDs) are passed out of the plasma volume based on the respective ones of the nanodiamonds reaching a size greater than a threshold size. The respective ones of the nanodiamonds reaching the size greater than the threshold size are collected. Related nanodiamonds are also discussed.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/702,439 filed on Oct. 2, 2024. The disclosure of Provisional Application No. 63/702,439 and all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #212361.

### TECHNICAL FIELD

The present disclosure relates to nanoparticles, and more particularly, to nanodiamond particles and related methods.

### BACKGROUND OF THE INVENTION

Scalable engineering of solid-state quantum devices can open new avenues for quantum sensing, quantum-information processing, and quantum networks development. Solid-state spins are a leading contender in quantum technology. Systems such as optically active point impurity defects/color centers in diamond have been investigated thoroughly. Among those color centers are nitrogen-vacancy (NV) center, SiV, GeV, SnV, PbV, MgV, NiV, Nic centers and others.

From the viewpoint of materials science, the key criterion for good coherence properties is excellent diamond crystal quality. For increased/maximum efficiency, an NV center shouldn't “see” in its vicinity any defects, such as intrinsic crystal lattice defects which induce strain (e.g., vacancies, dislocations, stacking faults, etc.), impurities, or impurity complexes. Additionally, the diamond should be isotopically pure to reduce/minimize nuclear spins.

For most applications in quantum physics, it may be important/essential to use NV⁻ centers as close as possible to the diamond surface (e.g., ˜20 nm or less below the surface) to couple the emitted photoluminescence efficiently to a photonic waveguide or a microcavity, for example.

Many potential quantum applications of NV centers rely on their integration into nano-photonic structures. Waveguide structures can enhance the collection efficiency of emitted light of the NV center, improving the fidelity of the spin state measurement. Cavity structures can enhance the emission of NV centers at a single frequency, increasing the indistinguishability of photon emission which may be useful/necessary for entanglement distribution. Many implementations of these devices rely on the fabrication of the nanophotonic structure into the diamond crystal itself, followed by irradiation to create the NV defect within the device. However, this approach may present serious technical challenges and/or limitations due to the superlative hardness of diamond, lack of scalable undercutting technique for diamond membrane fabrication, and/or the probabilistic nature of defect creation within the fabricated structure.

Nanodiamonds (NDs) may provide an elegant alternative to fabricated diamond nanoscale structures to exploit NV centers located at nanometer distances from the diamond surface as they can be heterogeneously integrated in designed photonic structures such as photonic crystals, waveguides, and resonant cavities capable of confining, guiding, and enhancing their emission for use in quantum sensing, quantum computing, and/or quantum networks development. Efficiently coupling NVs in nanodiamonds to existing, mature photonics platforms, such as in silicon, may offer advances in quantum communications and/or quantum sensing.

Nanodiamonds are also nontoxic and chemically inert and may exhibit excellent biocompatibility for biolabeling and conjugation of molecules like drugs and genes for their intracellular and extracellular delivery. Room temperature optically detected magnetic resonance (ODMR) spectroscopy opened the way to use NDs as nanoscale quantum sensors inside living cells for imaging in bio and medical research and for measurement of magnetic and electric fields, radical concentration, temperature, and pH.

However, despite significant interest and progress in development of ND quantum applications, issues hindering effectiveness of actual NDs may include one or more of: 1) Poor ND crystal quality; 2) Poor control of particle size and size distribution; 3) Poor control of ND purity; 4) Poor control of ND doping, i.e. poor control of impurity defects concentration in NDs including, but not limited by N atoms, NV⁻ centers; and/or 5) Instability of the charge state of near-surface NV centers (uncontrolled switching among NV, NV⁰, and NV⁺), which may be strongly affected by surface defects, surface termination, and adsorbates. The first four of these issues may be directly related to ND synthesis methods.

There are several common ND synthesis methods including: (1) Dynamic synthesis using detonation techniques; (2) Ball milling of high pressure high temperature (HPHT) or chemical vapor deposition (CVD) diamond crystals; (3) Laser ablation; (4) High pressure and high temperature (HPHT) synthesis; and (5) Chemical vapor deposition (CVD). Detonation NDs may have inherently poor crystalline quality and/or poor chemical purity. Somewhat higher crystalline quality and/or higher purity has been achieved by milling and laser ablation, but NDs produced by these methods may still exhibit high strain, irregular shape, and/or wide particle size distribution. The longest T₂ time reported for NDs is for milled NDs and is only 400 μs (see, Reference [1]). To date, the best crystallinity has been demonstrated in HPHT NDs synthesized at pressures higher than 7 GPa (see, Reference [2]). However, purity and precise doping control may be major challenges in HPHT synthesis. CVD may be well suited to fabricate nanocrystalline diamond films, but growing individual diamond nanoparticles on a substrate may be a very low-yield process.

Regarding the fifth issue noted above (i.e., instability of the charge state of near-surface NV centers), control or stabilization of the charge state and the optical properties of the NV center may be critical and can be achieved by controlling the position of the Fermi level within the bandgap. This can be performed, for example, passively using chemical control of the charge state via surface termination with oxygen or fluorine (see References [3] and [4]).

Accordingly, there continues to exist a need in the art for improved methods of forming quantum-grade nanodiamonds (Q-NDs) (also referred to as quantum-grade nanodiamond particles or quantum grade diamond nanoparticles).

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, a method of forming quantum-grade nanodiamonds (Q-NDs) includes providing a plasma volume in a reaction chamber of a plasma reactor and providing molecular seeds in the plasma volume. A carbon precursor is provided in the plasma volume to grow diamond around each of the molecular seeds in the plasma volume to provide nanodiamonds (NDs). Ones of the nanodiamonds (NDs) are passed out of the plasma volume based on the respective ones of the nanodiamonds reaching a size greater than a threshold size. The respective ones of the nanodiamonds reaching the size greater than the threshold size are collected.

Providing the molecular seeds may include providing the molecular seeds in a vapor state in a flow of a carrier gas (e.g., through a molecular seed and carrier gas port), with the flow of the carrier gas being provided through the plasma volume. The molecular seeds may be provided by sublimating the molecular seeds to the vapor state. The carrier gas may include at least one of hydrogen, argon, methane, and/or mixtures thereof. Each of the nanodiamonds may be electrostatically trapped in the plasma volume until reaching the size greater than the threshold size, and the respective ones of the nanodiamonds may be passed out of the plasma volume responsive to the respective ones of the nanodiamonds reaching the size greater than the threshold size due to the flow of the carrier gas. Particle trapping is discussed, for example, in Referenced [7] and [8] (full citations of which are provided below), the disclosures of which are hereby incorporated herein in their entireties by reference.

The molecular seeds may be diamondoid seeds, such as adamantane (C₁₀H₁₆) seeds, diamantane (C₁₄H₂₀) seeds, triamantane (C₁₈H₂₄), tetramantane (C₂₂H₂₈), pentamantane (C₂₆H₃₂) and/or higher diamondoid seeds. Each of the diamondoid seeds may be a diamondoid derivative seed including a non-carbon dopant atom having an atomic weight greater than 2. According to some embodiments, each of the diamondoid derivative seeds may include the non-carbon dopant atom substituted for a carbon atom in the structure of the diamondoid seed, such as azaadamantane (C₉H₁₅N) seeds. According to some other embodiments, each of the diamondoid derivative seeds may include the non-carbon dopant atom added to the carbon atoms in the structure of the diamondoid derivative seed, such as aminoadamantane (C₁₀H₁₇N) seeds.

The carbon precursor may be a hydrocarbon compound, such as methane.

The threshold size may be defined as a nanodiamond particle diameter greater than 2 nm, greater than 5 nm, greater than 8 nm, and/or greater than 10 nm.

Collecting may include collecting the respective ones of the nanodiamonds reaching the size greater than the threshold size in a nanodiamond particle collector outside the reaction chamber.

In addition, a dopant precursor for a dopant element may be provided (e.g., through dopant precursor gas port) in the plasma volume, and the dopant element may be included in the diamond grown around each of the molecular seeds. The dopant precursor may include (without being limited to) at least one of diborane (so that boron dopant atoms are included in the diamond grown around each of the molecular seeds), arsine (so that arsenic dopant atoms are included in the diamond grown around each of the molecular seeds), and/or phosphine (so that phosphorus atoms are included in the diamond grown around each of the molecular seeds).

In addition, a non-diamond nanoshell may be formed on the respective ones of the nanodiamonds (NDs) having the size greater than the threshold size to provide nanoshell coated nanodiamonds after passing the respective ones of the nanodiamonds (NDs) reaching the size greater than the threshold size out of the plasma volume. The non-diamond nanoshell may include at least one of an oxide nanoshell, a nitride nanoshell, a fluoride nanoshell, and/or a metal nanoshell. According to some embodiments, forming the non-diamond nanoshell may include providing a nanoshell precursor gas (e.g., through a coating precursor gas port) into a coating zone of the reaction chamber, and the respective ones of the nanodiamonds having the size greater than the threshold size may move from the plasma volume to the coating zone, the nanoshell coated nanodiamond may move from the coating zone out of the reaction chamber (e.g., through an exhaust port), and collecting may include collecting the nanoshell coated nanodiamonds. According to some other embodiments, forming the non-diamond nanoshell may include moving the respective ones of the nanodiamonds having the size greater than the threshold size out of the reaction chamber (e.g., through an exhaust port), and forming the non-diamond nanoshell may include forming the non-diamond nanoshell outside the reaction chamber.

According to some other embodiments of inventive concepts, a quantum-grade nanodiamond (Q-ND) includes a nanodiamond having only a single impurity defect therein. The single impurity defect, for example, may be an atom of nitrogen as a dopant or a single NV⁻ center. Moreover, the nanodiamond may have a diameter of at least 5 nm.

In addition, the Q-ND may include a non-diamond semiconductor nanoshell on the nanodiamond. The non-diamond semiconductor nanoshell, for example, may include a semiconductor oxide nanoshell. More particularly, the semiconductor oxide nanoshell may include a doped semiconductor oxide nanoshell, such as a doped metal oxide (e.g., zinc oxide) nanoshell. For example, the semiconductor oxide nanoshell may be an aluminum doped zinc oxide nanoshell.

According to still other embodiments of inventive concepts, a quantum-grade nanodiamond (Q-ND) includes a nanodiamond and a non-diamond semiconductor nanoshell on the nanodiamond. The non-diamond semiconductor nanoshell, for example, may include a semiconductor oxide nanoshell. More particularly, the semiconductor oxide nanoshell may include a doped semiconductor oxide nanoshell, such as a doped metal oxide (e.g., zinc oxide) nanoshell. For example, the semiconductor oxide nanoshell may be an aluminum-doped zinc oxide nanoshell.

Moreover, the nanodiamond may have only a single dopant atom therein, such as an atom of nitrogen, and the nanodiamond may have a diameter of at least 5 nm.

### BRIEF DESCRIPTION OF DRAWINGS

Examples of embodiments of inventive concepts may be more clearly understood from the following detailed description taken in conjunction with the accompanying drawings in which:

FIGS. 1A, 1B, and 1C respectively illustrate the diamondoid molecules adamantane (C₁₀H₁₆), diamantine (C₁₄H₂₀), and triamantane (C₁₈H₂₄) that may be used according to some embodiments of inventive concepts;

FIGS. 2A and 2B respectively illustrate the diamondoid derivatives aminoadamantane (C₁₀H₁₇N) or azaadamantane (C₉H₁₅N) that may be used according to some embodiments of inventive concepts;

FIG. 3 is a schematic block diagram illustrating a plasma reactor that may be used to form nanodiamonds according to some embodiments of inventive concepts;

FIG. 4 is a flow chart illustrating operations of forming nanodiamonds according to some embodiments of inventive concepts;

FIG. 5 illustrates a quantum-grade nanodiamond according to some embodiments of inventive concepts; and

FIG. 6 is a cross sectional view illustrating a quantum-grade nanodiamond of FIG. 5 encapsulated in a nanoshell according to some embodiments of inventive concepts.

### DETAILED DESCRIPTION OF THE INVENTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and/or convenience of explanation.

To more fully realize the potential of NDs in quantum applications, the present disclosure proposes methods of forming quantum-grade nanodiamonds (Q-NDs) wherein: Q-NDs should have well controlled particle size and narrow particle size distribution; Q-NDs should be substantially free of strain, dislocations and stacking faults; Q-NDs should be substantially chemically and isotopic pure; each Q-ND should have only one (or another precise number) of color-centers (e.g., NV⁻), and/or the charge of each NV⁻ center should be stable.

According to some embodiments of inventive concepts, quantum-grade nanodiamonds (Q-NDs) having reduced/minimal crystal lattice defects and/or strain may be provided.

According to some embodiments of inventive concepts, quantum-grade nanodiamonds (Q-NDs) having relatively high chemical and/or isotopic purity may be provided.

According to some embodiments of inventive concepts, quantum-grade nanodiamonds (Q-NDs) having well-controlled particle size and/or narrow particle size distribution may be provided.

According to some embodiments of inventive concepts, quantum-grade nanodiamonds (Q-NDs) having only one or another precise number of color-centers (e.g., NV⁻) may be provided.

According to some embodiments of inventive concepts, quantum-grade nanodiamonds (Q-NDs) having stable charge states of the color-centers (e.g., NV⁻) may be provided.

According to some embodiments of inventive concepts, quantum-grade nanodiamonds (Q-NDs) containing color centers with enhanced inhomogeneous spin-dephasing time (T₂*) and/or enhanced Hahn-echo spin-coherence time (T₂) may be provided.

According to some embodiments of inventive concepts, methods to produce such Q-NDs may be provided.

These and other aspects of inventive concepts may be accomplished by novel processes of making Q-NDs described in detail in the following disclosure.

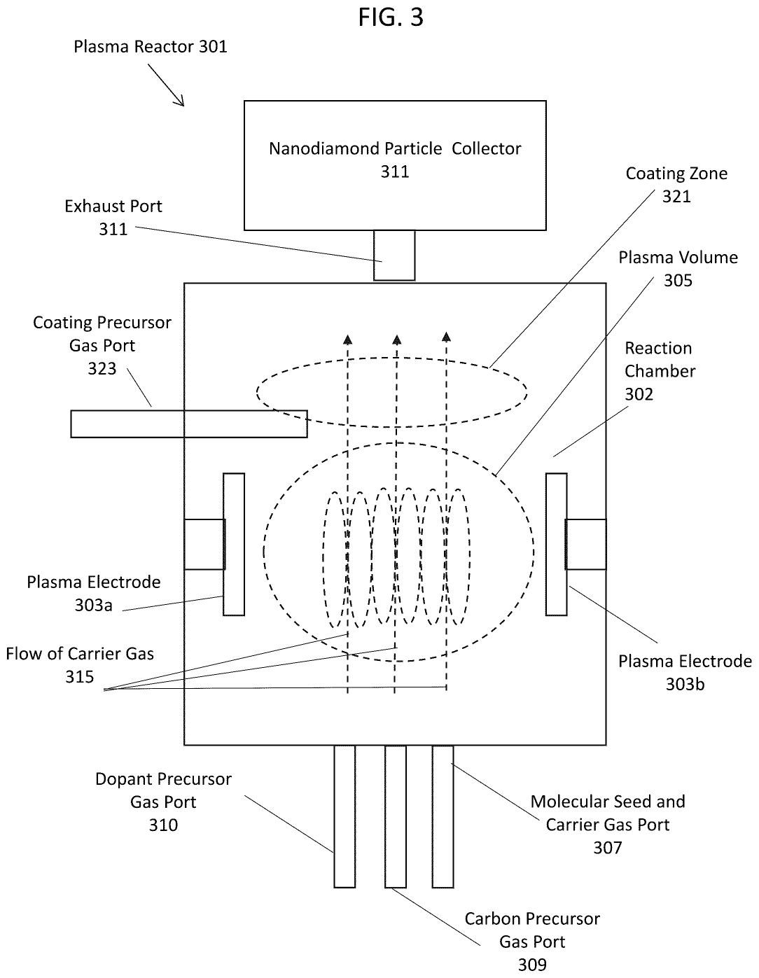

In accordance with some embodiments of inventive concepts, the processes may include one or more of the elements/operations discussed below to make Q-NDs. FIG. 3 is a schematic block diagram illustrating a plasma reactor 301 that may be used to form nanodiamonds according to some embodiments of inventive concepts.

A first element/operation to make Q-NDs uses a plasma reactor 301 in which precursors (e.g., molecular seed, carbon, and/or dopant precursors) flow through the plasma volume 305 where nanodiamonds can nucleate and grow volumetrically while they are inside of the plasma volume 305. The plasma can be generated by a radio frequency (RF) or microwave (MW) electromagnetic field generated by plasma electrodes 303a and 303b. These plasmas, which contain electrons, ions, neutral gas, and electric and/or magnetic fields along with solid particles, are called dusty plasmas. Nanoparticles in plasmas are generally negatively charged and mutually repel each other, which strongly suppresses or eliminates the particle agglomeration that encumbers other synthesis methods. Dusty plasmas offer excellent size control for the grown nanodiamonds (also referred to herein as diamond nanoparticles and/or nanodiamond particles). In most cases, a nanoparticle's size is correlated with its residence time in the plasma. Plasmas are discussed, for example, in Reference [9] (a full citation of which is provided below), the disclosure of which is hereby incorporated herein in its entirety by reference.

Nanoparticles can be temporarily trapped electrostatically in laminar flow during their growth, typically close to the RF electrodes 303a and/or 303b, leading to size filtering that enables very monodisperse size distributions. For example, molecular seeds and a carbon precursor may be provided (e.g., through molecular seed and carrier gas port 307 and carbon precursor gas port 309) to plasma volume 305 where diamond grows on the molecular seeds to form nanodiamonds, and growth of each nanodiamond in the plasma volume may continue until the respective nanodiamond reaches a threshold size (e.g., a diameter of at least 5 nm, at least 8 nm, and/or at least 10 nm), at which point the flow 315 of carrier gas is sufficient to move the nanodiamond having the threshold size out of the plasma volume and through exhaust port 311.

A second element/operation is use of diamondoids as the molecular seeds for the heterogeneous nucleation and growth of Q-NDs.

Diamond is a metastable sp³ carbon phase at low pressures, but it can be grown at metastable conditions from hydrocarbons such as CH₄ in a hydrogen plasma, like in CVD diamond growth, because carbon in diamond has lower chemical potential than carbon in methane. However, during this metastable growth, diamond encounters strong competition from stable sp² carbon phases, mainly graphite and diamond-like carbon (DLC). In light of this, growth of NDs by homogeneous nucleation is particularly challenging because it may require carbon supersaturation higher than that needed for diamond growth on surfaces. The higher supersaturation accelerates formation of sp² phases. Thus, it would be reasonable to start growth of NDs on seeds with diamond crystal structure, although to grow nanometer-sized diamonds, the seeds should be of molecular size in addition to being homogeneous and pure.

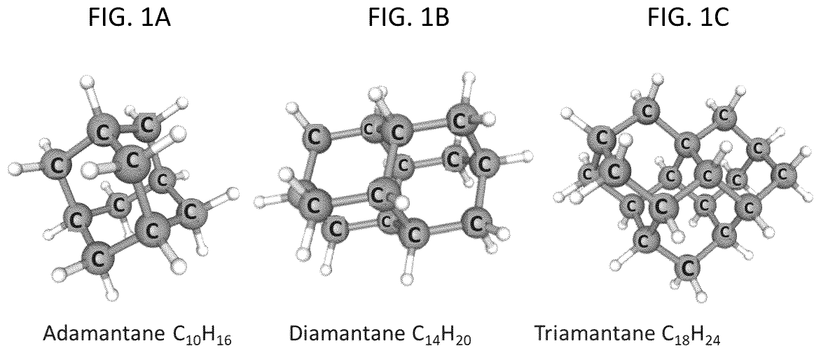

Diamondoid molecules, such as adamantane (C₁₀H₁₆), diamantine (C₁₄H₂₀), and/or triamantane (C₁₈H₂₄) shown in FIGS. 1A, 1B, and 1C, may be ideally suited to seed ND growth in a synthesis plasma. Hydrogen termination of all carbon atoms makes diamondoids very stable in the ambient and in a hydrogen plasma environment. Molecular-sized seeds possessing a perfect diamond cubic lattice and stability at growth conditions may be optimal seeds/substrates to grow reduced-defect/defect-free Q-NDs. Diamondoids in the form of a powder of molecular crystals are sublimed inside the reactor, and diamondoid molecules are delivered by a pressure difference or by carrier gas to the plasma volume 305 inside the reactor 301 as seeds for Q-ND growth.

Using high-purity methane, hydrogen, and other precursors may provide high purity Q-NDs with an option to use pure ¹²CH₄ and ¹²C diamondoids to grow isotopically pure Q-NDs. FIGS. 1A, 1B, and 1C respectively illustrate Adamantane C₁₀H₁₆, Diamantane C₁₄H₂₀, and Triamantane C₁₈H₂₄.

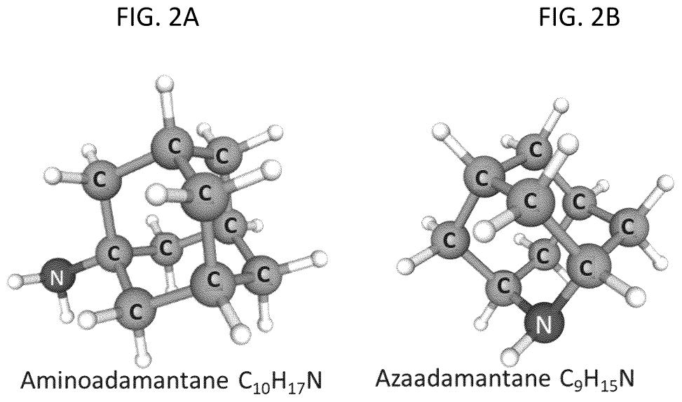

A third element/operation may include using modified/functionalized diamondoid derivatives which may have one or more carbon atoms substituted by another element or one or more atoms other than carbon added to a diamondoid molecule. These modified/functionalized diamondoid derivatives are used as molecular seeds for Q-NDs growth and simultaneously as a source of a dopant for precise nano-doping of Q-NDs. For example, aminoadamantane C₁₀H₁₇N or azaadamantane C₉H₁₅N shown in FIGS. 2A and 2B, respectively, are used as seeds and simultaneously as sources of only one nitrogen atom per Q-ND grown around of such seed.

If required color centers are impurity-vacancy defects, vacancies can be generated by any known technique including electron or neutron irradiation (at room temperature or at elevated temperature), ion implantation, and other techniques. After vacancies are formed, Q-NDs can be annealed at predetermined temperatures to cause vacancy diffusion and to form color centers as impurity-vacancy pairs or impurity defect complexes.

A fourth element/operation is an n-type or p-type semiconductor nanoshell, such as an oxide deposited on the Q-ND surface and terminated by a predetermined species, such as H, O, F, OH or another functional group.

Color centers can have different charge states, including NV and NV⁰ states or SiV⁰, SiV⁻ and SiV²⁻ states. For different applications, specific charge states of a color center may need to be stabilized. This can be performed in Q-NDs with NV, for example, via Q-ND surface termination with oxygen or fluorine.

For example, an oxygen-terminated Q-ND surface can stabilize the NV center and increase its coherence time. The coherence time, T₂, of NV⁻ centers in CVD diamond thin films has been increased by approximately one order of magnitude via annealing at high temperature (e.g., 800° C.) under an O₂ atmosphere, which has been shown to produce a highly-ordered oxygen-terminated surface with relatively few surface defect states (see Reference [5]). T₂ can be similarly improved in dusty-plasma-synthesized Q-NDs via either a similar ex situ annealing treatment or by an in situ/in-flight oxygen plasma treatment in the synthesis reactor. According to the fourth element/operation, a deposited thin shell (e.g., <1 nm, about 1 nm, or about 2 nm) of a heavily doped n-type metal oxide (e.g., Al- or O-vacancy-doped ZnO) on top of this oxygen-terminated ND surface may serve to: (1) reduce/prevent oxygen from leaving the surface under vacuum and/or under elevated temperatures; (2) protect the Q-ND surface from adsorbates and thus preserve the improved T₂; and/or (3) provide a reservoir of free electrons that reduces the driving force for electron transfer from NV⁻ to the ND surface and thereby stabilize the negatively charged NV state. The deposition of this nanoshell can be done either in situ in a double-plasma core-shell-synthesis dusty plasma reactor configuration or ex situ via particle atomic layer deposition (pALD). Plasma synthesis is discussed, for example, in Reference (a full citation of which is provided below), the disclosure of which is hereby incorporated herein in its entirety by reference.

A fifth element/operation is co-doping of Q-NDs with elements preserving the charge state of the designed color center to improve/enhance the center stability and coherence.

For example, to control and stabilize the charge state of NV⁻ centers, Q-NDs can be co-doped with phosphorous as electron donor impurity which may not have free spin interfering with NV spins. Dopants acting as electron donors and intrinsically assisting NV⁰→NV charge state conversion can provide that NV centers in diamond predominantly exist in the NV state. Twofold extension of the spin-coherence time T₂ in phosphorus-doped diamond was demonstrated (see Reference [6]).

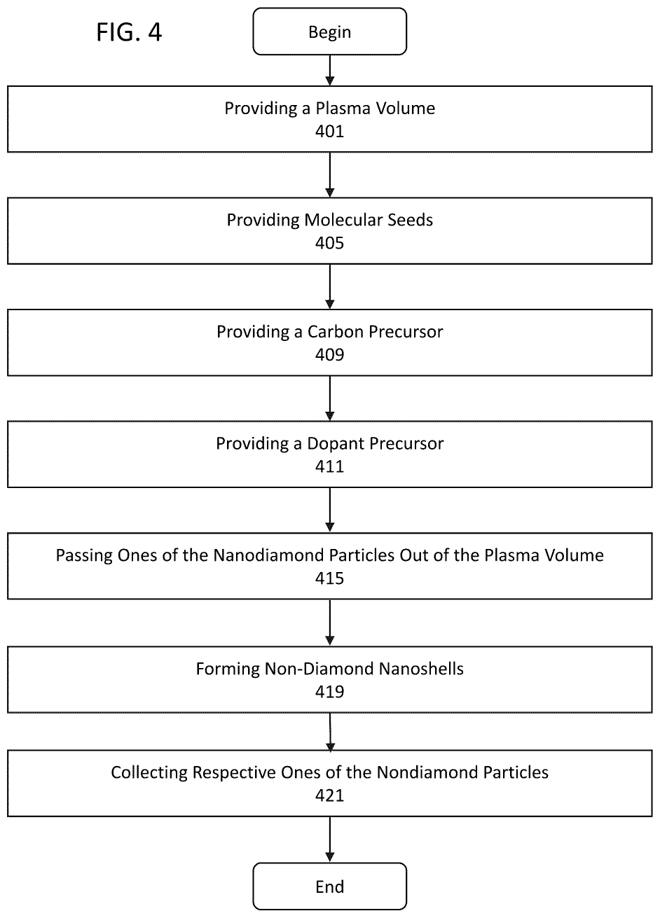

Methods of forming quantum-grade nanodiamonds (Q-ND) according to some embodiments of inventive concepts are discussed below with respect to the flow chart of FIG. 4.

At block 401, plasma volume 305 is provided in reaction chamber 302 of plasma reactor 301.

At block 405, molecular seeds are provided in plasma volume 305. According to some embodiments, providing the molecular seeds at block 405 may include providing the molecular seeds in a vapor state in a flow 315 of a carrier gas (e.g., through molecular seed and carrier gas port 307), with the flow of the carrier gas being provided through the plasma volume 305. For example, providing the molecular seeds may include sublimating the molecular seeds to the vapor state, and/or the carrier gas may include at least one of hydrogen, argon, methane, and/or mixtures thereof.

The molecular seeds of block 405 may be diamondoid seeds. According to some embodiments, the diamondoid seeds may include at least one of adamantane (C₁₀H₁₆) seeds, diamantane (C₁₄H₂₀) seeds, triamantane (C₁₈H₂₄), tetramantane (C₂₂H₂₈), pentamantane (C₂₆H₃₂) and/or higher diamondoid seeds.

According to some other embodiments, the diamondoid seeds may include a diamondoid derivative seed including a non-carbon dopant atom having an atomic weight greater than 2. Each of the diamondoid derivative seeds, for example, may include the non-carbon dopant atom substituted for a carbon atom in the structure of the diamondoid seed, such as azaadamantane (C₉H₁₅N) seeds. In an alternative, each of the diamondoid derivative seeds may include the non-carbon dopant atom added to the carbon atoms in the structure of the diamondoid derivative seed, such as aminoadamantane (C₁₀H₁₇N) seeds.

At block 409, a carbon precursor is provided in plasma volume 305 (e.g., through carbon precursor gas port 309) to grow diamond around each of the molecular seeds in the plasma volume 305 to provide nanodiamonds (ND). The carbon precursor, for example, may include a hydrocarbon compound such as methane.

At block 411, a dopant precursor for a dopant element is provided in plasma volume 305 (e.g., through dopant precursor gas port 310) so that the dopant element is included in the diamond grown around each of the molecular seeds. For example, the dopant precursor may include at least one of: a boron precursor such as diborane (so that boron dopant atoms are included in the diamond grown around each of the molecular seeds); an arsenic precursor such as arsine (so that arsenic dopant atoms are included in the diamond grown around each of the molecular seeds); and/or a phosphorus precursor such as phosphine (so that phosphorus atoms are included in the diamond grown around each of the molecular seeds).

At block 415, ones of the nanodiamonds (NDs) are passed out of the plasma volume 315 based on the respective ones of the nanodiamonds reaching a size greater than a threshold size. For example, each of the nanodiamonds may be electrostatically trapped in the plasma volume 305 until reaching the size greater than the threshold size, and the respective ones of the nanodiamonds may be passed out of the plasma volume responsive to the respective ones of the nanodiamonds reaching the size greater than the threshold size due to the flow of the carrier gas. The threshold size may be defined, for example, as a nanodiamond diameter greater than 5 nm, greater than 8 nm, and/or greater than 10 nm.

At block 419, after passing the respective ones of the nanodiamonds (NDs) reaching the size greater than the threshold size out of the plasma volume 315, non-diamond nanoshells may be formed on the respective ones of the nanodiamonds (NDs) having the size greater than the threshold size to provide nanoshell-coated nanodiamonds. For example, each of the non-diamond nanoshells may include at least one of an oxide nanoshell, a nitride nanoshell, a fluoride nanoshell, and/or a metal nanoshell.

According to some embodiments, forming the non-diamond nanoshells at block 419 may include providing a nanoshell precursor gas (e.g., through coating precursor gas port 323) into a coating zone 321 of the reaction chamber 302, wherein the respective ones of the nanodiamonds having the size greater than the threshold size move from the plasma volume 305 to the coating zone 321, and wherein the nanoshell coated nanodiamonds move from the coating zone 321 out of the reaction chamber 302 (e.g., through exhaust port 311).

According to some other embodiments, forming the non-diamond nanoshells at block 419 may include moving the respective ones of the nanodiamonds having the size greater than the threshold size out of the reaction chamber 302 (e.g., through exhaust port 311), and forming the non-diamond nanoshells outside the reaction chamber 302.

At block 421, the respective ones of the nanodiamonds reaching the size greater than the threshold size are collected. For example, the respective ones of the nanodiamonds reaching the size greater than the threshold size may be collected in a nanodiamond collector 311 outside the reaction chamber 302.

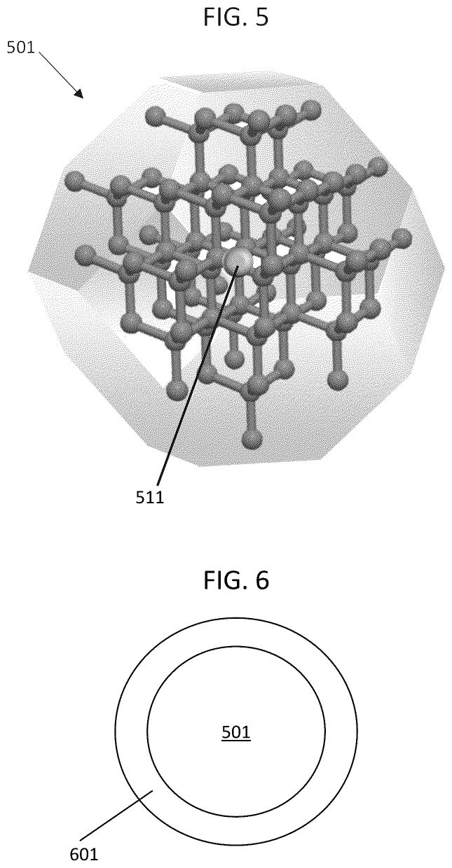

FIG. 5 illustrates an example of a quantum-grade nanodiamond (Q-ND) 501 that may be provided according to some embodiments of inventive concepts, for example, using methods discussed above. As shown in FIG. 5, a single dopant atom 511 (e.g., nitrogen) may be centered in an array of carbon atoms of Q-ND 501, and Q-ND 501 having only single dopant atom 511 may have a diameter greater than 2 nm, greater than 5 nm, greater than 8 nm, or even greater than 10 nm. In addition, a non-diamond semiconductor shell may be provided on the Q-ND 501.

The cross sectional view of FIG. 6 illustrates Q-ND of FIG. 5 encapsulated in a non-diamond semiconductor nanoshell according to some embodiments of inventive concepts. Q-ND 501 of FIG. 6 may be provided as discussed above with respect to FIG. 5, and non-diamond semiconductor nanoshell 601 may be provided thereon to encapsulate Q-ND 501. Non-diamond semiconductor nanoshell 601 may be a doped semiconductor oxide nanoshell, such as a doped metal oxide nanoshell. For example, the doped semiconductor oxide nanoshell may be a doped metal oxide nanoshell, such as an aluminum-doped zinc oxide nanoshell.

According to some embodiments of inventive concepts, nanodiamonds may be provided for diamond based quantum applications that may be used to provide quantum sensing, quantum computers, and/or quantum communications. Such quantum applications may include: quantum inertial devices (e.g., used to provide navigation in GPS degraded or denied environments); quantum intelligence, surveillance, and/or reconnaissance (ISR) devices; quantum sensors paired with quantum computers to enhance ISR applications; secure networking of quantum sensors, computers, and/or other systems; and/or quantum key distribution (OKD) to encrypt information in classical networks.

Example Embodiments of inventive concepts are provided below.
Embodiment 1. A method of forming quantum-grade nanodiamonds (Q-NDs) particles, the method comprising: providing a plasma volume in a reaction chamber of a plasma reactor; providing molecular seeds in the plasma volume; providing a carbon precursor and hydrogen in the plasma volume to grow diamond around each of the molecular seeds in the plasma volume to provide nanodiamonds (NDs) particles; passing ones of the nanodiamond particles out of the plasma volume based on the respective ones of the nanodiamond particles reaching a size greater than a threshold size; and collecting the respective ones of the nanodiamond particles reaching the size greater than the threshold size.
Embodiment 2. The method according to Embodiment 1, wherein providing the molecular seeds comprises providing the molecular seeds in a vapor state in a flow of a carrier gas, wherein the flow of the carrier gas is provided through the plasma volume.
Embodiment 3. The method according to Embodiment 2, wherein providing the molecular seeds comprises sublimating the molecular seeds to the vapor state.
Embodiment 4. The method according to Embodiment 2, wherein the carrier gas comprises at least one of hydrogen, argon, methane, and/or mixtures thereof.
Embodiment 5. The method according to Embodiment 2, wherein each of the nanodiamonds particles is electrostatically trapped in the plasma volume until reaching the size greater than the threshold size, and wherein the respective ones of the nanodiamonds particles are passed out of the plasma volume responsive to the respective ones of the nanodiamonds particles reaching the size greater than the threshold size due to the flow of the carrier gas.
Embodiment 6. The method according to Embodiment 1, wherein the molecular seeds comprise diamondoid seeds.
Embodiment 7. The method according to Embodiment 6, wherein the diamondoid seeds comprise at least one of adamantane (C₁₀H₁₆) seeds, diamantane (C₁₄H₂₀) seeds, triamantane (C₁₈H₂₄), tetramantane (C₂₂H₂₈), pentamantane (C₂₆H₃₂) and/or higher diamondoid seeds.
Embodiment 8. The method according to Embodiment 6, wherein each of the diamondoid seeds comprise a diamondoid derivative seed include a non-carbon dopant atom having an atomic weight greater than 2.
Embodiment 9. The method according to Embodiment 8, wherein each of the diamondoid derivative seeds includes the non-carbon dopant atom substituted for a carbon atom in the structure of the diamondoid seed.
Embodiment 10. The method according to Embodiment 9, wherein the diamondoid derivative seeds comprise azaadamantane (C₉H₁₅N) seeds.
Embodiment 11. The method according to Embodiment 8, wherein each of the diamondoid derivative seeds includes the non-carbon dopant atom added to the carbon atoms in the structure of the diamondoid derivative seed.
Embodiment 12. The method according to Embodiment 11, wherein the diamondoid derivative seeds comprise aminoadamantane (C₁₀H₁₇N) seeds.
Embodiment 13. The method according to Embodiment 1, wherein the carbon precursor comprises a hydrocarbon compound.
Embodiment 14. The method according to Embodiment 13, wherein the carbon precursor comprises methane.
Embodiment 15. The method according to Embodiment 1, wherein the threshold size is defined as a nanodiamond particle diameter greater than 5 nm, greater than 8 nm, and/or greater than 10 nm.
Embodiment 16. The method according to Embodiment 1, wherein collecting comprises collecting the respective ones of the nanodiamonds particles reaching the size greater than the threshold size in a nanodiamond particle collector outside the reaction chamber.
Embodiment 17. The method according to Embodiment 1 further comprising: providing a dopant precursor for a dopant element in the plasma volume, wherein the dopant element is included in the diamond grown around each of the molecular seeds.
Embodiment 18. The method according to Embodiment 17, wherein the dopant precursor includes at least one of diborane so that boron dopant atoms are included in the diamond grown around each of the molecular seeds, arsine so that arsenic dopant atoms are included in the diamond grown around each of the molecular seeds, and/or phosphine so that phosphorus atoms are included in the diamond grown around each of the molecular seeds.
Embodiment 19. The method according to Embodiment 1 further comprising: after passing the respective ones of the nanodiamonds particles reaching the size greater than the threshold size out of the plasma volume, forming a non-diamond nanoshell on the respective ones of the nanodiamonds particles having the size greater than the threshold size to provide nanoshell-coated nanodiamonds particles.
Embodiment 20. The method according to Embodiment 19, wherein the non-diamond nanoshell comprises at least one of an oxide nanoshell, a nitride nanoshell, a fluoride nanoshell, and/or a metal nanoshell.
Embodiment 21. The method according to Embodiment 19, wherein forming the non-diamond nanoshell comprises providing a nanoshell precursor gas into a coating zone of the reaction chamber, wherein the respective ones of the nanodiamonds particles having the size greater than the threshold size move from the plasma volume to the coating zone, and wherein the nanoshell coated nanodiamonds particles move from the coating zone out of the reaction chamber, and wherein collecting comprises collecting the nanoshell coated nanodiamonds particles.
Embodiment 22. The method according to Embodiment 19, wherein forming the non-diamond nanoshell comprises moving the respective ones of the nanodiamonds particles having the size greater than the threshold size out of the reaction chamber, and wherein forming the non-diamond nanoshell comprises forming the non-diamond nanoshell outside the reaction chamber.
Embodiment 23. A quantum-grade nanodiamond (Q-ND) comprising: a nanodiamond having only a single dopant atom or impurity defect therein.
Embodiment 24. The Q-ND according to Embodiment 23, wherein the single dopant atom or impurity defect is an atom of nitrogen.
Embodiment 25. The Q-ND according to Embodiment 24, wherein the single impurity defect is a single NV center.
Embodiment 26. The Q-ND according to Embodiment 24, wherein the single impurity defect is one of the single SiV, GeV, SnV, PbV, MgV, NiV, Nic color-centers.
Embodiment 27. The Q-ND according to Embodiment 23 further comprising: a non-diamond semiconductor nanoshell on the nanodiamond.
Embodiment 28. The Q-ND according to Embodiment 27, wherein the non-diamond semiconductor nanoshell comprises a semiconductor metal oxide nanoshell.
Embodiment 29. The Q-ND according to Embodiment 28, wherein the semiconductor metal oxide nanoshell comprises a doped semiconductor metal oxide nanoshell.
Embodiment 30. The Q-ND according to Embodiment 29, wherein the doped semiconductor oxide nanoshell comprises a doped metal oxide nanoshell.
Embodiment 31. The Q-ND according to Embodiment 23, wherein the nanodiamond has a diameter of at least 5 nm.
Embodiment 32. A quantum-grade nanodiamond (Q-ND) comprising: a nanodiamond; and a non-diamond semiconductor nanoshell on the nanodiamond.
Embodiment 33. The Q-ND according to Embodiment 32, wherein the wherein the non-diamond semiconductor nanoshell comprises a semiconductor metal oxide nanoshell.
Embodiment 34. The Q-ND according to Embodiment 33, wherein the semiconductor metal oxide nanoshell comprises a doped semiconductor metal oxide nanoshell.
Embodiment 35. The Q-ND according to Embodiment 34, wherein the doped semiconductor oxide nanoshell comprises a doped metal oxide nanoshell.
Embodiment 36. The Q-ND according to Embodiment 32, wherein the nanodiamond has only a single dopant atom therein.
Embodiment 37. The Q-ND according to Embodiment 36, wherein the single dopant atom is an atom of nitrogen.
Embodiment 38. The Q-ND according to Embodiment 35, wherein the nanodiamond has a diameter of at least 5 nm.

Complete citations are provided below for References cited in the present disclosure, and the disclosures of these references are hereby incorporated herein in their entireties by reference.
Reference [1]. WOOD, B. D., et al., “Long spin coherence times of nitrogen vacancy centers in milled nanodiamonds,” Physical Review B (US), Vol. 105, Issue 20, pages 205401-1 to 205401-10, May 2, 2022.
Reference [2]. EKIMOV, E. A., et al., “High-pressure synthesis and optical properties of nanodiamonds obtained from halogenated adamantanes,” Diamond and Related Materials (NL), Vol. 103, 107718, 10 pages, March 2020.
Reference [3]. HAUF, M. V. et al., “Chemical control of the charge state of nitrogen-vacancy centers in diamond,” Phys. Rev. B-Condens. Matter Mater. Phys. (US), Vol. 83, Issue 8, pages 081304-1 to 081304-4, Feb. 14, 2011.
Reference [4]. CUI, S., et al., “Increased negatively charged nitrogen-vacancy centers in fluorinated diamond,” Appl. Phys. Lett. (US), Vol. 103, pages 051603-1 to 051603-4, Aug. 1, 2013.
Reference [5]. SANGTAWESIN, S., et al., “Origins of Diamond Surface Noise Probed by Correlating Single-Spin Measurements with Surface Spectroscopy,” Physical Review X (US), Vol. 9, Issue 3, pages 031052-1 to 031052-17, Sep. 26, 2019.
Reference [6]. WATANABE, A. T., et al., “Shallow NV centers augmented by exploiting n-type diamond,” Carbon (NL), Vol. 178, pages 294-300, Jun. 30, 2021.
Reference [7]. XIONG, Z., et al., “Particle trapping, size-filtering, and focusing in the nonthermal plasma synthesis of sub-10 nanometer particles,” J. Phys. D: Appl. Phys. (UK), Vol. 55, 235202, 13 pages (2022).
Reference [8]. ESLAMISARAY, M. A., et al., “A Single-Step Bottom-up Approach for Synthesis of Highly Uniform Mie-Resonant Crystalline Semiconductor Particles at Visible Wavelengths,” Nano Lett. (US), Vol. 23, pages 1930-1937 (2023).
Reference [9]. KORTSHAGEN, U. R., “Nonthermal Plasma Synthesis of Nanocrystals: Fundamental Principles, Materials, and Applications,” Chem. Rev. (US), Vol. 116, pages 11061-11127 (2016).
Reference [10]. HUNTER, K. I., et al., “Nonthermal Plasma Synthesis of Core/Shell Quantum Dots: Strained Ge/Si Nanocrystals,” ACS Appl. Mater. Interfaces (US), Vol. 9, pages 8263-8270 (2017).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on”, “connected” to/with, or “coupled” to/with another element, it can be directly on, connected to/with, or coupled to/with the other element, or intervening elements may be present. In contrast, when an element is referred to as being “directly on”, “directly connected” to/with, or “directly coupled” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concept. Moreover, the sizes/thicknesses of elements/layers may be exaggerated for clarity and convenience of explanation.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

Unless otherwise defined, all terms (including technical and scientific terms) used herein have the same meaning as commonly understood by one of ordinary skill in the art to which inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. A method of forming quantum-grade nanodiamonds (Q-NDs), the method comprising:
providing a plasma volume in a reaction chamber of a plasma reactor;
providing molecular seeds in the plasma volume;
providing a carbon precursor and hydrogen in the plasma volume to grow diamond around each of the molecular seeds in the plasma volume to provide nanodiamonds (NDs);
passing ones of the nanodiamonds out of the plasma volume based on the respective ones of the nanodiamonds reaching a size greater than a threshold size; and
collecting the respective ones of the nanodiamonds reaching the size greater than the threshold size.

2. The method according to claim 1, wherein providing the molecular seeds comprises providing the molecular seeds in a vapor state in a flow of a carrier gas, wherein the flow of the carrier gas is provided through the plasma volume.

3. The method according to claim 1, wherein the molecular seeds comprise diamondoid seeds.

4. The method according to claim 3, wherein each of the diamondoid seeds comprise a diamondoid derivative seed include a non-carbon dopant atom having an atomic weight greater than 2.

5. The method according to claim 4, wherein each of the diamondoid derivative seeds includes the non-carbon dopant atom substituted for a carbon atom in the structure of the diamondoid seed.

6. The method according to claim 5, wherein the diamondoid derivative seeds comprise azaadamantane (C₉H₁₅N) seeds.

7. The method according to claim 4, wherein each of the diamondoid derivative seeds includes the non-carbon dopant atom added to the carbon atoms in the structure of the diamondoid derivative seed.

8. The method according to claim 7, wherein the diamondoid derivative seeds comprise aminoadamantane (C₁₀H₁₇N) seeds.

9. The method according to claim 1, wherein the threshold size is defined as a nanodiamond diameter greater than 5 nm.

10. The method according to claim 1 further comprising:
providing a dopant precursor for a dopant element in the plasma volume, wherein the dopant element is included in the diamond grown around each of the molecular seeds.

11. The method according to claim 1 further comprising:
after passing the respective ones of the nanodiamonds reaching the size greater than the threshold size out of the plasma volume, forming a non-diamond nanoshell on the respective ones of the nanodiamonds having the size greater than the threshold size to provide nanoshell-coated nanodiamonds.

12. The method according to claim 11, wherein the non-diamond nanoshell comprises at least one of an n- or p-type semiconductor nanoshell, oxide nanoshell, a nitride nanoshell, a fluoride nanoshell, and/or a metal nanoshell.

13. A quantum-grade nanodiamond (Q-ND) comprising:
a nanodiamond having only a single impurity defect therein.

14. The Q-ND according to claim 13, wherein the single impurity defect is a dopant atom of nitrogen.

15. The Q-ND according to claim 14, wherein the single impurity defect is a single NV or NV⁻ center.

16. The Q-ND according to claim 13 further comprising:
a non-diamond nanoshell on the nanodiamond.

17. The Q-ND according to claim 16, wherein the nanoshell comprises an n-type or p-type semiconductor nanoshell.

18. The Q-ND according to claim 17, wherein the n-type or p-type semiconductor nanoshell comprises a metal oxide nanoshell.

19. The Q-ND according to claim 13, wherein the nanodiamond has a diameter of at least 5 nm.

20. A quantum-grade nanodiamond (Q-ND) comprising:
a nanodiamond; and
a non-diamond nanoshell on the nanodiamond.

21. The Q-ND according to claim 20, wherein the wherein the non-diamond nanoshell comprises an n- or p-type semiconductor nanoshell.

22. The Q-ND according to claim 21, wherein the n- or p-type semiconductor nanoshell comprises a semiconductor metal oxide nanoshell.
